(19) United States
(12) Patent Application Publication
(10) Pub. No.: US 2019/0093038 A1
(43) Pub. Date: Mar. 28, 2019

(54) System for Gasification on Demand

(71) Applicant: Leonard Ortiz, Gallatin, TN (US)

(72) Inventor: Leonard Ortiz, Gallatin, TN (US)

(21) Appl. No.: 15/732,135

(22) Filed: Sep. 22, 2017

(51) Int. Cl. C10L 3/00; B01B 1/00

(52) U.S. Cl. CPC C10L 3/00; C10L 2290/18; C10L 2290/06; B01B 1/005

(57) ABSTRACT

A process for converting liquefied carbon based fuels into dry gas.

### BACKGROUND OF INVENTION

### Field of the Invention

The present invention relates, to the universal acceleration of the natural gasification process, through the use of an assembly of metallic and fabric membrane substrates, placed inline with fuel flow, as one or more, wafer mantle insert(s) or a cylindrical cartridge insert(s), to control the on demand gasification phase changes, of liquefied carbon based fuels, from liquid to dry gas, where the metallic substrates must be physically connected to each other and to the hot metal housing of the apparatus or engine utilizing the dry gas generated by this process.

Gasification

Gasification is the natural occurrence of liquids or solids metamorphosing from one natural state to another, i.e. liquids to vapor, to dry gas or solids to fumes to dry gas. Gasification naturally extracts the maximum energy from solids and liquids, i.e. crude oil burns more efficiently than coal, gasoline burns more efficiently than diesel, and gasified gasoline is 130% more efficient than liquid gasoline.

Gasification is all around us. It is a common by product of the air dryer in the public bathrooms, the clothes dryer, the septic sewer system, forest fires, melting glaciers etc., in agriculture the drying of grains naturally in bins or accelerated with blowers in grain dryers etc. The most common accelerated gasification is in the mantles of gasoline camping lanterns and gasoline camping stoves.

The domestic benefit of my gasification process is that our U.S. oil resources can be multiplied a staggering 130% in gasoline fuel alone. Our military vehicles' fuel supplies will last twice as long in combat. Harnessing and accelerating this natural phenomenon can better the human experience by dramatically reducing the pollution of our environment and recover massive amounts of energy that would otherwise be wasted by obsolete technology.

### BRIEF INVENTION SUMMARY

My invention utilizes common materials, components and concepts to create an efficient, streamlined, method for controlled acceleration of the phases of gasification. My invention is composed of 1) a gasification mantle or mantle inserts and 2) a single or a multiple of fuel injectors with aerators, misters, or nebulizers to create a micro-fog according to the application that when used as defined herein accelerate the gasification of fluids into dry gas.

Advantages: My invention
Utilizes overlooked simplicity that when properly applied yields univerally benefits
Is highly adaptable to existing applications with few modifications required: internal combustion engines: land, sea, air; furnaces: industrial or home; distillers; wood gasifiers, trash recyclers etc.
Requires no additional electricity or electronics
Is relatively inexpensive
Is highly effective in increasing the fuel's power, cleanness, conservation
Is very safe
Will eliminate catalytic converters, diesel smoke & much of municipal waste
Eliminates the need for compressed gas cylinders in hybrid applications, i.e. automobiles
Is ideal for third world countries' conservation of energy and reduction of carbon footprint.
Requires absolute minimal field service and parts replacement

### BRIEF DRAWINGS DESCRIPTION

FIG. 1 is a drawing that depicts a simple side view representation of a flat gasification wafer mantle insert assembly of metal and fabric substrates

FIG. 2 is a drawing that depicts a typical gasification flat wafer mantle insert in a fuel injection engine application

FIG. 3 is a drawing depicting a typical cylindrical fuel injector engine gasification insert and assembly

### DETAILED DESCRIPTION

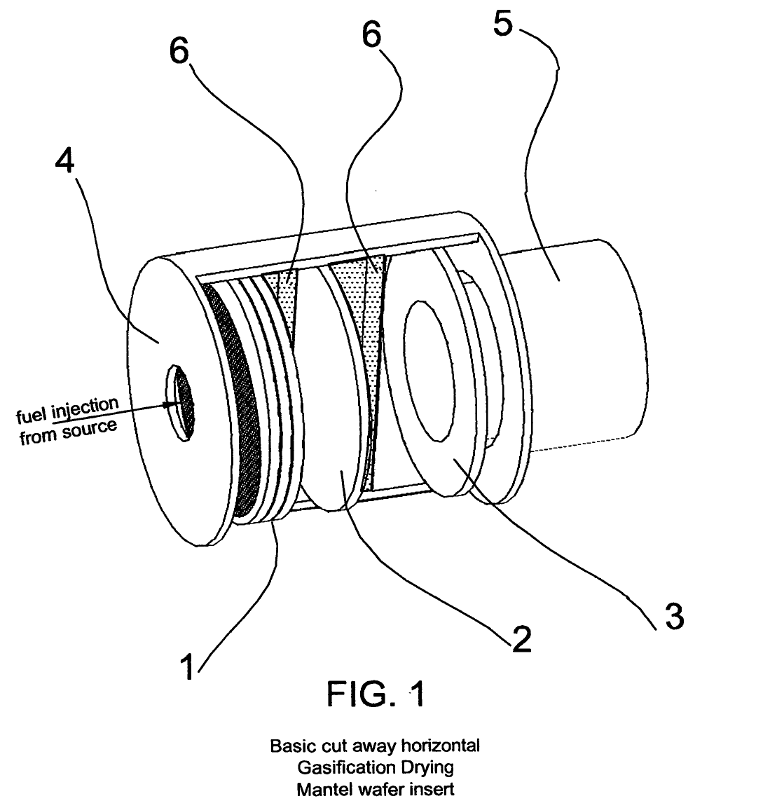

FIG. 1 is a drawing that depicts a representation of a foundational flat gasification wafer mantle insert assembly of metal and fabric substrates, where #1, #2, #3 are metal substrates and #6 are fabric substrates. #4 depicts the fuel injector input on the metal housing and #5 depicts the output metal extension that fits into the receiving apparatus. The foundational substrates may vary in quantity and material based on the application.

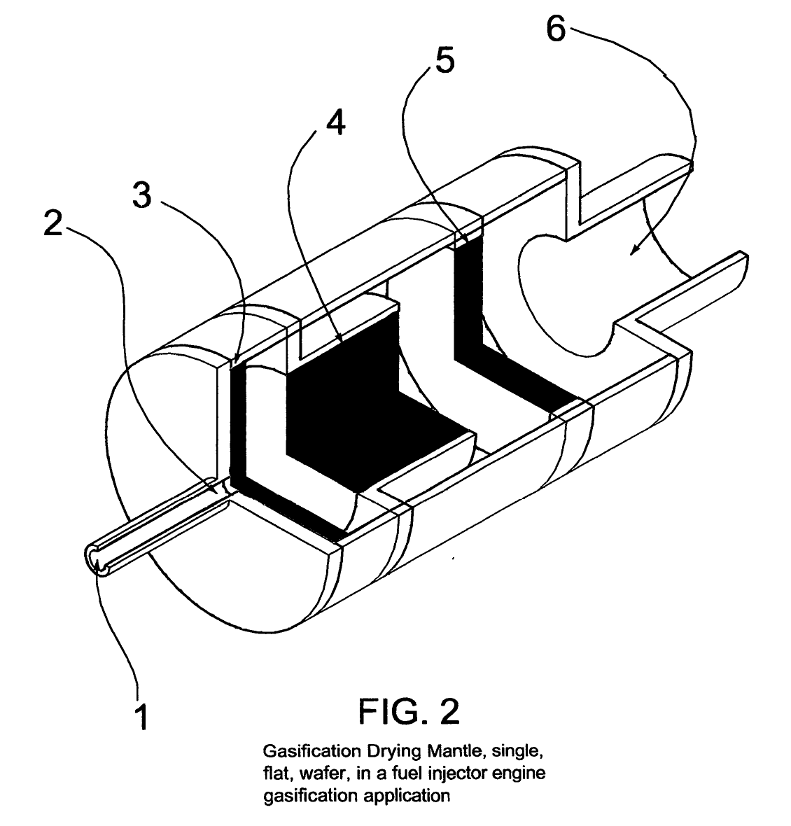

FIG. 2 is representative of one of many apparatuses that would benefit from the use of dry gas, i.e., is a depiction based on an eight-cylinder engine functioning on a single injector with the gasification mantle insert. The single injector and gasification nebulizer are controlled by the pulses delivered by the apparatus i.e., automobile's computer. #1 and #6 are connecting extensions, #2 is the input for a pulse controlled fluid injector with an appropriately sized nozzle which supplies a spray of micro mist, onto #3 a gasification metal mantle insert, which flows into #4 a micro fiber substrates, and #5 a metal mantle insert, which interconnect to each other and to the manifold, which must:

1). be inserted in line with the nozzle such that the spray onto a) the mantle of substrates covers the #3 intake metal mantle screen so b) the vacuum of the engine draws that fuel and air mixture through to c) the #4 fabric membrane.

2). then in like manner, consecutively onto #5 metal substrate, each metal substrate being physically connected with the manifold by the #6 connecting extension thus transferring engine heat to metal substrates #3 and #5. 3) the combined mantles will detain and retain the mist phase changing droplets 4) while a controlled airflow, provided by the apparatus vacuum or blower, drives the air through the mantle's vapor retaining substrates thereby accelerating the molecular change of vapors to gas in the emulsifying, metamorphosing process, thereby producing dry-gas on demand.

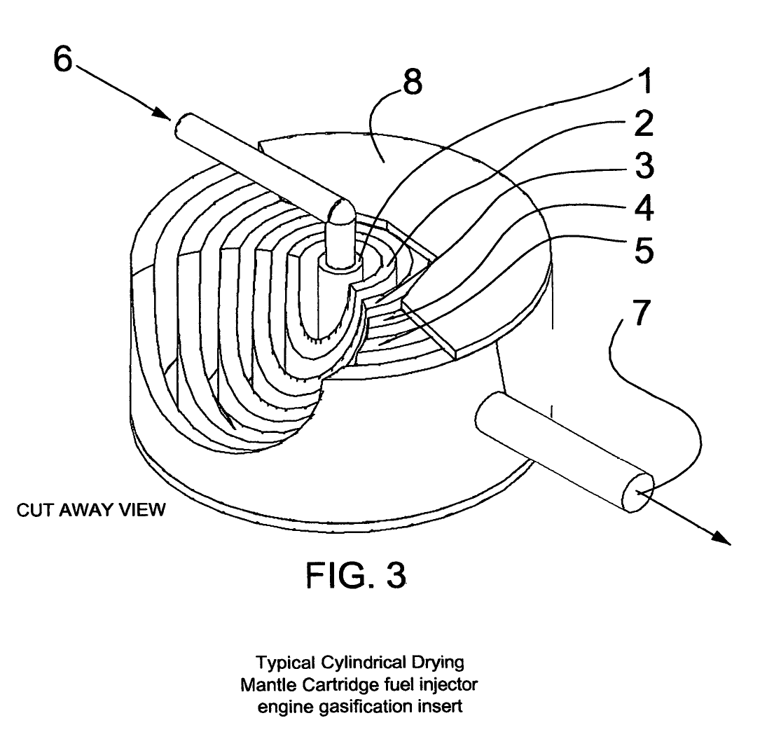

FIG. 3 is a drawing depicting a typical cylindrical fuel injector engine gasification insert and assembly where #6 is the wet fuel injector intake, #7 is the dry gas output to the apparatus, #8 is the metal cylinder body of the cartridge, #1, #3 and #5 are the heated metal substrates, #2 and #4 are fabric substrates. Fuel spray injected flows through #1, #3 and #5 metal substrates, and #2 and #4 fabric substrate, #7 exiting the cylinder as dry-gas that has been emulsified in the metamorphosing process.

1. A process for accelerating the natural gasification of liquefied carbon based fuels by installing a properly configured mantle or mantles of perforated metals and fabric substrates, inline with the flow of air and nebulized liquid carbon based fuels mixture, where each component in each mantle is chosen based on:
a. Air flow velocity
b. the properties of the liquid carbon base fuel
c. the appropriate size of the nozzle, aerator
d. the appropriate nebulizer and substrates,
e. the appropriate hole sizes on metal screens
f. the appropriate fabric density, permeability, operating temperature, dissolvability of man made or natural fiber and fluid absorbance properties

2. The process for accelerating the natural process of gasification of liquefied carbon based fuels according to claim 1 by utilizing a nebulizer to create a fog mixture and mantles, which are standalone wafer inserts, flat, round, square, cubes or tubular, composed of alternating metal to fabric substrates or alternating metal to metal substrates, of different perforation sizes, in the number and composition dictated by the liquefied fuel presented for gasification, that together accelerate the molecular decomposition of liquefied fuels into dry gas.

3. The process for accelerating the natural process of gasification of liquefied carbon based fuels according to claim 2, wherein the metal substrates are directly heated by being attached to the engine or apparatus metal, to excite the nebulized fuel in its phases of accelerated gasification

4. The process for accelerating the gasification of liquefied carbon based fuels according to claim 1, wherein the mixture is passed through an environment beginning at ambient temperature and rising to a prescribed effective temperature.

5. The process for accelerating the gasification of liquefied carbon based fuels according to claim 1a, wherein the consistent airflow required is created the utilizing apparatus, either by a vacuum or a blower

6. The process for accelerating the gasification of liquefied carbon based fuels according to claim 1b, alcohol, vegetable oils, gasoline, diesel, emulsion etc.

7. The process for accelerating the gasification of liquid carbon based fuels according to claim 1c, where the nozzle or aerator size is a function of the viscosity of the liquefied carbon based fuel and the demand of the engine or consuming apparatus.

8. The process for accelerating the gasification of liquefied carbon based fuels according to claim 2, where the temperature is attained by having the three or more metal substrates, in each mantle, interconnected to each other and to the engine or apparatus housing, where onto they are attached, to conduct the temperature of the apparatus back onto the mantles' metal screens by the apparatus utilizing the on demand gasified fuel.

9. The process for accelerating the gasification of liquefied carbon based fuels according to claim 1d,e, where substrates in the mantle, whether metal or fabric, are determined by the viscosity of the fluid

10. The process for accelerating the gasification of liquefied carbon based fuels according to claim 1f, where fabric must be carefully chosen based on the absorbance, permeability, chemical compatibility with the fluid, disintegrating properties, its melt temperature, and viscosity of the fluid.

11. The basic principles, methods, concepts, or methodologies herein described are inclusive because they may be adapted to the processing of most carbon based liquefied combustible material, as they are produced in the process of mining, drilling, recycling of waste from ponds, mounds, or other storage areas, i.e., liquids, emissions from solids, emulsions.

12. None of these claims are limited to present technology, but are understood to include any changes in technology that may arise and be applied while using the same basic principles, methods, concepts, or methodologies ascribe to herein.
